(19) United States
(12) Patent Application Publication
(10) Pub. No.: US 2009/0265279 A1
(43) Pub. Date: Oct. 22, 2009

(54) SYSTEM AND METHOD FOR MANAGING AND DISTRIBUTING HEDGE FUND DATA

(75) Inventors: Gerald D. Mintz, Greenwich, CT (US); Roger Portnoy, London (GB); Gary L. Metzker, Reno, NV (US); Keith A. Knight, Sparks, NV (US); John M. Pettit, Reno, NV (US); Meredith A. Jones, Nashville, TN (US)

Correspondence Address: DARBY & DARBY P.C., P.O. BOX 770, Church Street Station, New York, NY, 10008-0770, US

(73) Assignee: Strategic Financial Solutions, LLC, New York, NY (US)

(21) Appl. No.: 12/106,159

(22) Filed: Apr. 18, 2008

(51) Int. Cl. G06Q 40/00; H04L 9/28

(52) U.S. Cl. 705/71; 705/36 R; 705/64

(57) ABSTRACT

A system for managing hedge funds includes a storage unit operable to store hedge fund information. The hedge fund information comprises at least one of a fund name, a fund share class, and denominated currency of a fund share class for a hedge fund. The system further includes a determination unit operable to determine, upon receiving hedge fund information, if the hedge fund information corresponds to a known hedge fund based on the received hedge fund information. The determination unit is operable to compare hedge fund information from a plurality of information sources so as to confirm whether the received hedge fund information relates to the same hedge fund.

### FIELD OF THE INVENTION

The present invention relates to a system and method for managing and distributing hedge fund data and, more particularly, to a system and method that allows a hedge fund manager to send secure data about verified funds via an electronic data exchange process to any investor and have that data integrated inside a database on the basis of a universal identification code.

### BACKGROUND OF THE INVENTION

Hedge fund managers offer investors access to various types of investment strategies. They seek to generate an absolute return on investment capital, called “alpha,” by employing strategies that will occasionally leverage the actual exposure to the market through the use of various types of financing arrangements. Hedge fund investors invest in fund structures offered by hedge fund managers by becoming limited partners in such vehicles. As limited partners, these investors seek to acquire an absolutely high return, particularly in a manner that is not highly correlated to market dynamics, often called “beta.”

Some Hedge Fund managers register their funds onshore, but the majority of funds seek to register their funds offshore. In most instances this means that hedge funds operate with limited regulatory oversight, and fiduciary responsibility. Disclosure and reporting requirements are negotiated agreements between investors, sometimes known as limited partners, and the hedge fund managers, also known as the general partners.

Hedge fund investors come in many forms, and can include professional institutional money managers that run multi-manager portfolios, family offices for high net worth individuals, endowments, private banks and trusts, etc. All of those who invest in hedge funds must be accredited investors, and will typically have certain rights provided to them in terms of reporting, access to managers, and fund investment and redemptions. With each type of hedge fund manager, the investment terms can be different, and the manager can acquire different types of information about the fund that they manage.

Investors in hedge funds normally allocate capital to investment vehicles structured in unit form that are administered and priced by an independent custodian. Investment vehicles of this type are often issued in more than one currency, with each issuance carrying its own registered class. For certain classes, hedge fund managers will also issue a numeric series in order to encompass specific covenants that have been agreed upon by the manager and the investor.

There are a number of strict investment guidelines incorporated into the structure of these vehicles. Qualified investors in hedge funds accept the principal that for a manager to generate high absolute return on capital, they need greater control over that capital. Thus, hedge funds are structured with limited redemption features, and long initial investment periods (known as “lock-ups”). These funds also carry fee structures that are different from traditional mutual funds. The fee structure on a hedge fund provides the hedge fund manager with the ability to capture a proportion of the total return of the fund vehicle (up to 50% depending on the amount invested) provided a minimum return is achieved for the fund. This fee is normally not re-distributed immediately to the manager, but becomes available to draw in the 2^{nd} or 3^{rd} year that the fund has been in operation. This structure acts as an incentive for the hedge fund manager to, within the limits of their strategy and risk profile, achieve as high an annual rate of return as possible.

Capital is acquired by hedge fund managers through a number of different routes. There are service providers of various kinds that assist hedge fund managers by providing capital introduction services. Hedge fund managers can also seek capital by submitting financial and background information to various types of information services sold to investors, as well as to various types of intermediaries of investment capital on behalf of high net worth individuals. Early in their evolution hedge funds tended to rely on both direct and indirect channels as well as strong performance to raise assets. In all instances, capital is only acquired from investors after significant due diligence, and a period of performance tracking which can lead to a marketing phase of as long as 6 months.

Hedge fund managers generally provide price guidelines in the form of an estimated monthly rate of return on each investment vehicle that they manage on an interim basis, and the administrator provides a net asset value for the fund on a monthly basis, as well as the final rate of return. It normally takes the administrator a week to calculate the final net asset value and deliver it to an investor, and can take longer if the underlying fund invests in instruments that are difficult to price.

Over the years hedge fund investors have grown more sophisticated in terms of how they seek to allocate capital to hedge fund managers. The institutionalization of the investment market, and particularly the entry of pension funds into the hedge fund segment seeking to generate high absolute returns, as opposed to relative returns, compared to market benchmarks, is certainly a contributing factor. However, investors have also become more conscious of the risk associated with various types of absolute return investment approaches and have thus sought to acquire greater amounts of data from hedge fund managers to better measure risk and reward.

However, hedge fund managers have been wary of developing a completely transparent model for reporting. Many managers argue that achieving a high absolute return strategy on a consistent basis requires some opaqueness, both in terms of strategy and position. Nevertheless as more managers have entered the market, and market regulators, such as the SEC, and FSA have become concerned about the growing amount of capital being allocated to managers providing absolute return products, most hedge fund management companies have started to devise a more transparent operational risk management approach, and with it, a better disclosure policy toward those seeking greater depth of information on a regular basis.

### SUMMARY OF THE INVENTION

The present invention to a method and system which allows hedge fund managers to provide more information to investors in a timely, secure and user friendly way in order to take advantage of the trend toward greater transparency.

In an illustrative embodiment of the present invention a complete straight-through process and system are proposed for reporting and distributing data on an electronic basis. The system, according to an embodiment of the present invention, includes a number of individual components, all of which together can contribute to delivering an application that allows hedge fund manager to capture all of the relevant data about themselves, and their funds. The system also allows transmission of this data on a peer-to-peer or one-to-many broadcast basis as is required by current market conditions, and which matches the disclosure policy that the manager wishes to maintain for that distribution channel. The system allows for the creation of a higher level of security around the data content than with other solutions in the market, and transmits data in a specific format, such as an XML structure. This methodology is superior to others in the market as it provides for more flexibility in terms of integration with other financial systems.

Further, the system provides the means by which the present invention can create many reports from a single template structure, herein referred to as a Pertrac card, or P-Card. The P-Card includes both data fields and data definitions that can be customized at both a group and a field level by a user. The P-Card can allow a hedge fund manager to select various types of qualitative and quantitative data fields they wish to send to investors on a regular basis, and to customize the values in these fields so that various types of investors can receive the information they want in the form that they want. This approach represents a far more scalable method of data distribution than that which can be achieved via a website or database platform, and also allows a hedge fund manager to manage data distribution and customization through a single connected software application environment.

STP is a business process for developing a marketing strategy through segmentation of the market, targeting the segment and then positioning the product or brand. The STP approach can be applied to P-Cards to allow the system of the present invention to directly integrate with other applications that have been developed for both hedge fund investors and managers. This provides the advantage of delivering data management, data distribution, and data integration in a single workflow, thus allowing manual data entry to be sharply reduced in a compliant and user-friendly manner. It allows hedge fund managers to register both existing and new funds and to dynamically generate identification codes, IDs, for these funds for data encryption purposes. Further, these identifiers can be specifically linked to data licenses so data can be sent to only those who are allowed to consume it. By having this linkage, the present invention can offer at least two layers of security.

### BRIEF DESCRIPTION OF THE DRAWINGS

The foregoing and other features of the present invention will be more readily apparent from the following detailed description and drawings of illustrative embodiments of the present invention in which:

FIG. 1 is a flow chart showing an embodiment of the system and method of the present invention;

FIG. 2 is a flow chart illustrating the web registration process according to an present invention;

FIG. 3 is a flow chart illustrating the web verification process according to an present invention;

FIG. 4 is illustrates the start page of the fund registration process according to an embodiment of the present invention;

FIG. 5 illustrates the second web page used by the hedge fund manager to search for their funds in the in the system according to an embodiment of the present invention;

FIG. 6 illustrates the third web page used by the hedge fund manager to register the mandatory attributes of their fund according to an embodiment of the present invention;

FIG. 7 illustrates the fourth web page used by the hedge fund manager to register the key points of contact according to an embodiment of the present invention;

FIG. 8 illustrates the fifth web page used by the fund administration officer to oversee the verification process of registered funds according to the illustrative embodiment of the present invention;

FIG. 9 illustrates the sixth web page used by the fund administration officer to review the details of a registration request and takes action according to the illustrative embodiment of the present invention;

FIG. 10 illustrates the seventh web page that is generated for the hedge fund manager after completion of the registration process according to an embodiment of the present invention;

FIG. 11 illustrates the installation module that is created for a hedge fund manager according to an embodiment of the present invention:

FIG. 12 illustrates the first component, the P-Card set up wizard module that forms the initial step in the configuration process for an embodiment of the present invention;

FIG. 13 illustrates the second component, the P-Card Import module of an embodiment of the present invention

FIG. 14 illustrates the third component, the P-Card Configuration module, of an embodiment of the present invention;

FIG. 15 illustrates the fourth component, the P-Card Distribution module, of an embodiment of the present invention;

FIG. 16 illustrates the fifth component, the P-Card Builder module of an embodiment of the present invention;

FIG. 17 illustrates the sixth component, the P-Card Customization module of an embodiment of the present invention;

FIG. 18 illustrates the seventh component, the P-Card Security module of the illustrative embodiment of the publishing application known as the P-Card Generator that forms the second element of the business process for the present invention.

FIG. 19 illustrates the eighth and final component, the P-Card Generation module, of an embodiment of the present invention;

FIG. 20 illustrates the first component, the P-Card Reader configuration module, of an embodiment of the present invention;

FIG. 21 illustrates the second component, the P-Card Reader data review module of an embodiment of the present invention;

FIG. 22 illustrates the third and final component, the P-Card Reader import module of an embodiment of the present invention;

FIG. 23 illustrates the first high level output of the P-Card Reader of an embodiment of the present invention; and

FIG. 24 illustrates the final detailed output of the P-Card Reader of an embodiment of the present invention

### DETAILED DESCRIPTION OF AN ILLUSTRATIVE EMBODIMENT OF THE INVENTION

The present invention is constructed as an interconnected series of components. Some of these components are provided as web services, others are provided as installed applications that utilize web services for authorization purposes, and still others are embedded components that work seamlessly with specific types of applications that can be delivered to users.

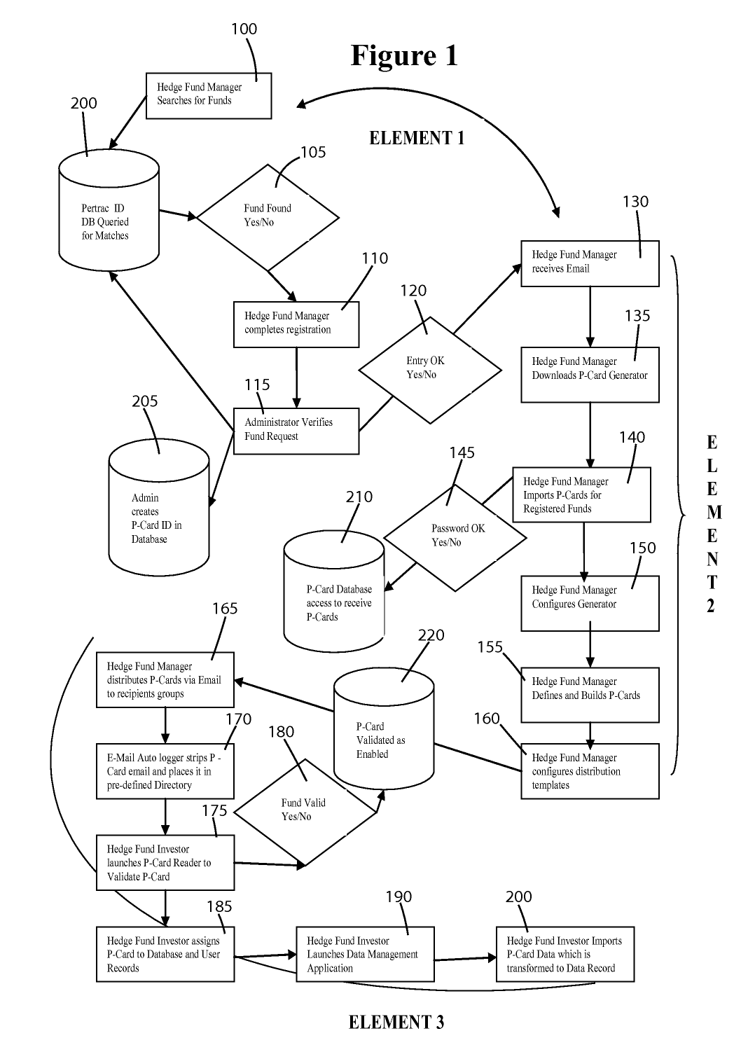

FIG. 1 shows the entire system and business process of an embodiment of the present invention. It is made up of 3 interconnected elements. These elements each involve data exchange between an application within the system and a database within the system.

Element 1

The first element of the system is a business process in the form of a web service. The web service involves the interaction between data submitted on web pages by a hedge fund manager, and a database of fund manager and fund names maintained by a system management company.

In step 100, the hedge fund manager in this embodiment of the present invention utilizes web pages to interface with the database 200 maintained by the system management company in order to inquire whether or not the manager's funds are currently stored in the database. Regardless of the result of the search in step 101, the hedge fund manager in step 102, will then submit further information about the funds that they wish to register. This information is submitted to a database specifically designed to store P-Card information, for example in an associated database schema. The manager also submits contact information to the database, thus creating both a fund record and a contact record as elements of the database.

After the manager has finished his process, the database is then accessed by a system management company administrator. The administrator at step 103 verifies existing funds, checks new data for all funds, and than approves the request for the funds to be registered. A P-Card is created and a P-Card Id is created in database 201. Once this process has been completed, and the database entry accepted, the administrator in step 104 generates an email to send to the registered user.

Element 2

The second element of the system is a business process that is executed via a system known as the P-Card Generator, which the manager downloads in step 105. The P-Card Generator, in the illustrative embodiment of the present invention, takes the form of a desktop computer application that duly manages an underlying database that can be configured to operate on a standalone computer or network basis.

The P-Card Generator contains within it a number of specific functions that a hedge fund manager will use for data creation, data management, and data distribution. These functions are currently delivered within a secure process, i.e. one that involves encryption and decryption procedures at the time of generation of the P-Card and acceptance, and transformation by the recipient.

The P-Card Generator has functions built within it to:
1) configure a number of pre-defined data field structures that are available to deliver via a P-Card;
2) manually enter data that is transformed into structured XML pre-defined fields;
3) import data via a mapping engine from other environments where data is held that needs to be stored and transported via the P-Card;
4) apply data elements in data fields that form part of one P-Card fund to other funds, so that such fields and data entries can become default entries for all or some P-Cards;
5) create a master P-Card that contains all transportable fields that can than be assigned at the field level to different recipient groups, thus allowing each recipient group to receive a customized version of the master P-Card in line with agreed distribution agreements between the manager and such recipients;
6) generate a version of each P-Card which is encrypted in a manner so that a user must have an appropriate decryption key to read and transform the underlying data structures into a usable database record;
7) import each P-Card using a secure connection over the Internet that has been verified and accepted; and
8) create a distribution process in the form of an e-mail that will automatically at the end of the publishing and generation process launch this application and attach the P-Card.

The business process in the illustrative embodiment of the present invention is designed for a hedge fund manager. It commences with an import process in step 106 from, e.g., the administrator verification. The import step provides information about funds that have been registered and accepted. In addition, in step 107 the hedge fund manager can import P-Cards for registered funds from database 202. Access to this database may be password protected and the manager will have to enter the appropriate password.

Once the information is obtained, a configuration process is started at step 108 that creates structure and rules associated with quantitative data sets that will be included in the P-Card design. To carry this out the manager uses the P-Card Generator obtained in step 109 to establish the quantitative data sets. These data sets include fields for tracking the performance of a hedge fund and may include a field for a rate of return over different periods, a field for the price for the fund based on its net asset value, and a field for the total assets under management in the fund.

After the configuration process is completed, the hedge fund manager defines a structure to apply to a single Fund or to multiple Funds that have been imported into the P-Card Generator. The illustrative embodiment of the present invention includes a number of pre-defined template structures that can be added, expanded, populated and edited by the hedge fund manager, and also includes a completely customizable template. If the manager uses this template in the present invention they have complete control over each data field, and can add, remove, and expand with complete flexibility. A hedge fund manager can manually input data into each field, copy and paste data from other applications into a field or create an import map to acquire data from another data management application. The import map in the present invention can be integrated into spreadsheets as well as common delimited files.

After the hedge find manager sets the template structure of the P-Card, he can also set a distribution template in step 110. This template defines what data is to be disseminated to which investors. The manager can than in step 111 generate the P-Card and e-mail it to all recipients, or create customized structures for specific recipient groups. This function is provided in the illustrative embodiment of the present invention to handle creating and distributing customized P-Cards to four different audiences, e.g., (1) existing fund investors, (2) prospective investors who are in due diligence, (3) qualified investors who are not in due diligence, and (4) trusted third parties such as prime brokers, custodians, database providers, etc. Of course, in other embodiments, fewer or additional audiences may be selected. The hedge fund manager has complete control over the generation process for each group and can change them at any time.

Once the distribution methodology has been decided in the hedge fund manager's last step is to generate the P-Card and distribute it via E-mail. As each P-Card goes through the generation process, a read only version of the P-Card is archived in the assigned fund manager's database 203. Each archived P-Card will be saved with a time stamp and with a name that matches which recipient for which the P-Card was generated. The generation process in the present invention is also responsible for providing encryption to the P-Card data structure. The encryption process encompasses both data directly imported or manually entered into the P-Card as well as files that are attached within the P-Card by the manager.

Element 3

The first step 112 of the third element of the business process in the present invention is handled by a plug-in application on e-mail. This application is designed in the present invention to recognize an e-mail attachment and to place this attachment file into a special folder. This folder is recognized by a P-Card Reader as the location where it should look to find new P-Cards.

In the illustrative embodiment, a hedge fund investor launches a P-Card Reader in step 113 in order to manage the P-Cards that have been placed in the folder created and managed by the e-mail application. The P-Card Reader is used by the hedge fund investor in stages. The first step of the business process is the verification of the P-Cards that have been received in step 114. This process is managed via a web service in which a P-Card is checked for validation with the P-Card database 203 maintained by system manager. If this validation process is successful, the P-Card Reader will validate whether the P-Card is a new part of the system or has been validated before. If it is a new P-Card the investor in step 115 will be asked to configure and identify the database, record, and structure that will use the data of the P-Card.

After this is completed, the recipient will than able to detach any attachment files that are provided with the P-Card and to review any changes that have been made to the P-Card. In the first instance, all elements of the P-Card are recognized as changes—in further imports, only changes from the newest P-Card to the next newest will be recognized as changes, and will be displayed as new values.

A recipient can decide to always review all changes to a P-Card prior to import and transformation or can bypass this process and have every P-Card transformed automatically. The transformation process in the illustrative embodiment of the present invention can either be executed to generate data structures that are suitable for common delimited files and spreadsheets, or for direct record creation in an existing analytical application, e.g., the Pertrac Analytical Platform available from www.pertrac.com, if the user is a subscriber to such a product. In such a case the investor launches the data management application in step 116 and imports the P-Card data which is then transferred to the data record in step 117.

The Pertrac Analytical Platform is a system used by hedge fund investor to perform various types of quantitative analysis on data provided directly by hedge funds as well as from 3^{rd} party data providers. The Pertrac Analytical Platform acts as a central data hub to manage both qualitative and quantitative data on a hedge fund or on multiple funds. The Pertrac Analytical Platform contains a statistical library that investors in hedge funds use in order to create and monitor hedge fund portfolios, as well as compare and contrast hedge funds in terms of their style, performance, and portfolio attribution. With the Pertrac Analytical Platform, a hedge fund investor, such as an endowment, fund of fund, investor advisor or pension fund can manage their own customized data, and perform complex performance and risk analysis on many different fields. The Pertrac Analytical Platform integrates with other Pertrac solutions and can be directly fed with data from the P-Card Data Management System.

In this transformation process, the data within the P-Card is automatically mapped into various types of pre-defined tables, with text items recognized and rendered as such, and numeric values being handled in exactly the same manner. Once a record has been created through the transformation process, in the present invention, the business process is completed.

P-Card Web Fund Registration Process

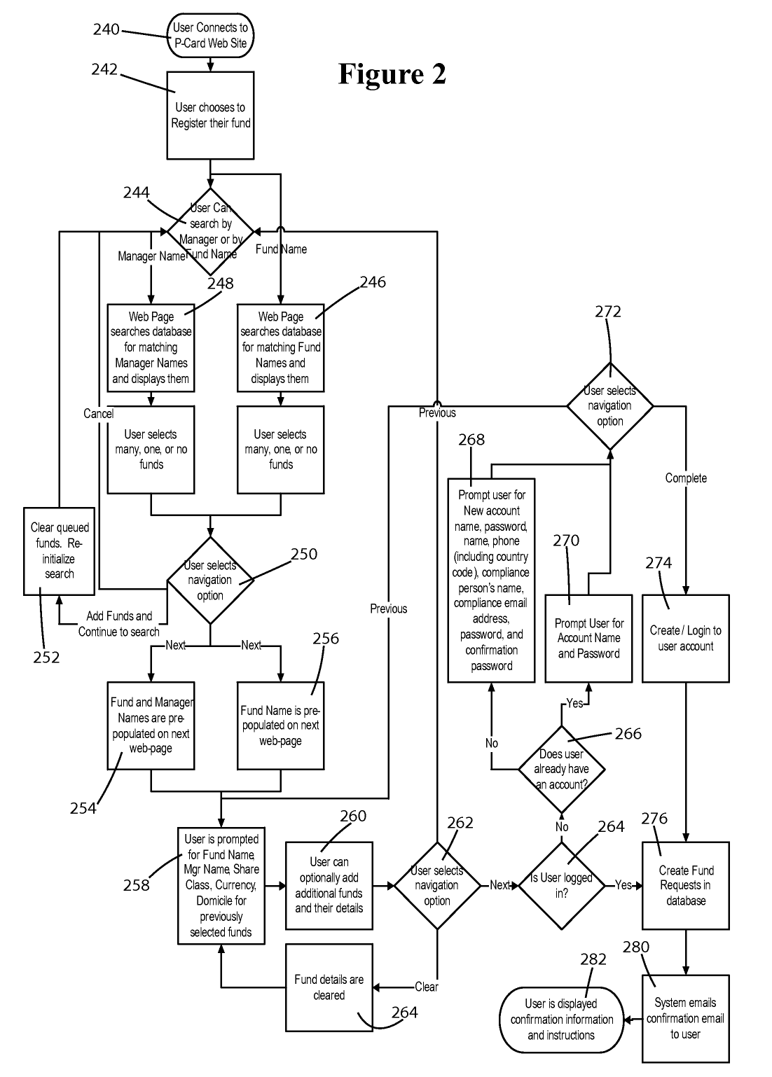

FIG. 2 is a flow chart of the processes for registering a new user to the web service and for acknowledging a returning user. There is no difference between the registration process for a new user and existing user although an existing user will also have access to other elements of the site involving account management in this embodiment of the present invention, while a new user will not. In particular, an existing user will also have access to information regarding their existing registered funds or pending registered requests that would not be applicable to a new user.

The registration process begins when the hedge fund manager as a user connects to the system web site in step 200. After this, the user chooses to register his fund in step 201. Next the hedge fund manager, using the fund search facility, either performs a search by fund manager name or by fund name in step 202. Both methodologies are run against the same database although the resulting outputs are in case of funds, produced on a line by line basis for the best matches in step 203, while for the manager route, the results are grouped under a manager hierarchy and are revealed by using an expand feature within the web page itself in step 204.

The fund registration process will either deliver, via the results screen, up to 2 pre-populated data fields (fund name, fund manager name) or will not if the fund is not found. The user determines whether to add funds and continue the search in step 205. In which case the previous results are cleared and the search is reinitialized.

A hedge fund manager registering existing or new funds will in either case be forced to supply some further data items in order to move on in the registration process in step 206. In the illustrative embodiment of the present invention these elements are the share class for the specified fund, the currency denomination of the fund associated with that class, and the onshore/offshore registration process.

The registration process is presented in the present embodiment to allow a hedge fund manager to optionally add to existing funds that are found within the database as well as add completely new funds that are not found in any shape or form in step 207. A situation where a manager might add to existing funds could be related to the currency denomination or the share class. A user can select the option to add additional fund information. This causes the original fund details to be cleared in step 208.

To proceed with the process the system checks to see if the user is logged-in at step 209. If the answer is no, the system questions whether the user has an account in step 210. If the answer is no, the user is prompted for new account information.

Once the fund registration details have been created, the last thing for a new user to do is to provide contact details. Contact details are also part of a mandatory data update procedure which requires inclusion of information about a second person other than the registered user. That person is the compliance officer, the person who usually overseas the operational aspect of reporting data to qualifying investors.

If the user has an account, the users is prompted for account name and password in step 211. If the user does not have an account, the system gives the user the option of completing the process. Next the account is created for a new user or an existing owner is logged into his account.

Once logged into the system, the user is allowed to create fund request in the data base. Each time the user registers a new fund or changes the status of a fund the system e-mails confirmation to the user in step 212.

P-Card Web Registration Verification Process

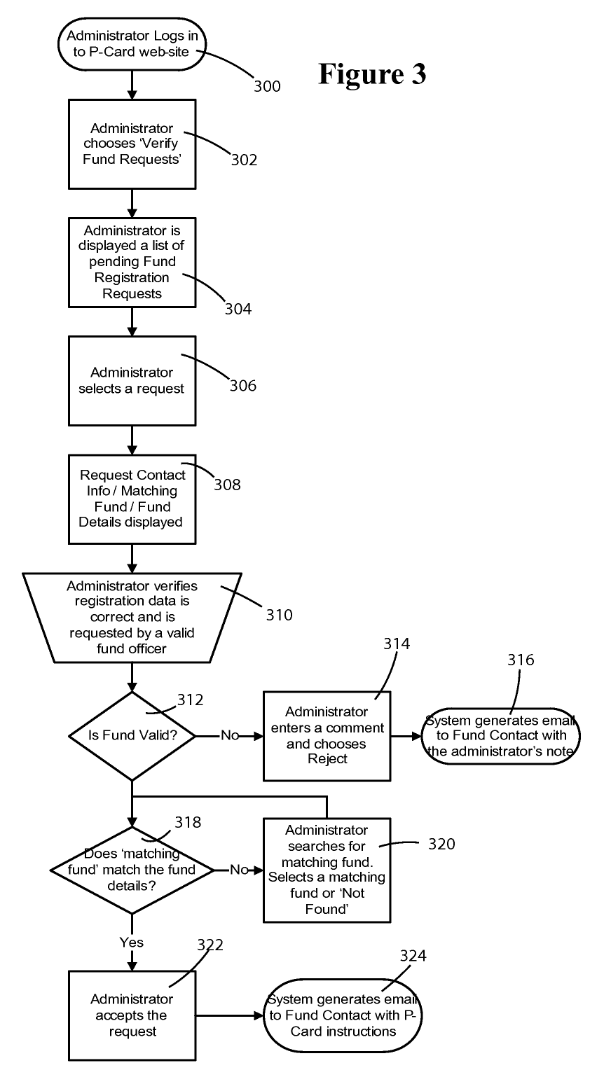

FIG. 3 illustrates an exemplary embodiment of a process for verification of the registration process which is carried out by the administration officer. It involves use of web assets, as well as database assets, and involves both manual and automated processes within the system. The verification process can be undertaken at a fund level, a contact level, or at a fund management firm level. In any of these approaches, the administration officer logs in to the system web site in step 300 and chooses the “Verify Fund Requests” option in step 301. The administrator is then presented with a list of pending fund registration requests in step 302 and selects a request in step 303.

Pending requests are verified through a few different processes. The first stage is always a database check to verify that the match that was identified by the hedge fund manager is correct against the registration request in step 304. This check will only yield results for a proportion of registered funds, as many funds are unlisted in databases.

The second aspect of the verification process involves the validation of the requester as both legitimate and authorized in step 305. A situation can arise in the illustrative embodiment of the present invention where a fund is rejected because the assignee is illegitimate or as failed to provide then necessary points of contacts.

If a fund request survives the matching check process, the contact validation process encompassing the compliance point of contact as well as the registered point of contact, then the fund can be accepted and a verification e-mail can be sent to the user and the compliance person in step 306.

If the fund is not valid, the administrator can enter a comment in the record and reject the request in step 307. The system sends an e-mail to the user with the administrator's note, e.g., explaining the rejection. If the fund is valid, the system determines whether the matching fund matches the fund details in step 308. If there is no match, the administrator searches for a matching fund. He then selects a matching fund or indicates match “Not Found.”

If the matching fund matches the details, the administrator accepts the request. This last process is performed by the system once the acceptance process is completed and can be configured to send one e-mail per fund, or one e-mail per manager as illustrated.

Web Service Components—P-Card Registration Screen

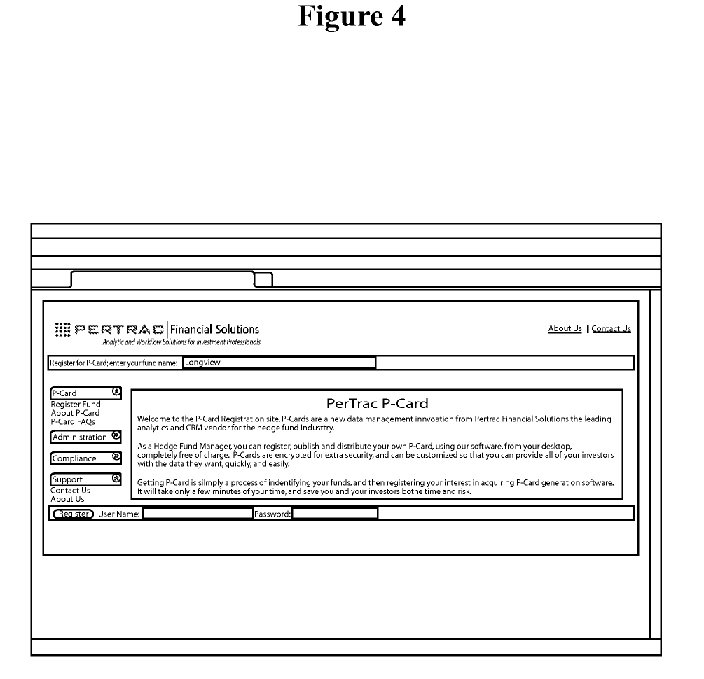

The present invention includes a number of web pages which are preferably dynamically generated. FIG. 4 illustrates a first page 400 according to an embodiment of the present invention. This first page introduces the hedge fund manager to the process by which they can acquire P-Cards and the software to generate P-Cards for their respective funds. As illustrated in FIG. 4, the first page 400 also operates as a home page for the web service for the registration by hedge fund managers of their interest in acquiring P-Cards for a particular fund.

The functionality of the first web page 400 includes a simple search facility, displayed as a search box 401 that allows a Hedge Fund Manager to put in the first part of a fund name in order to generate a list of possible matching funds. This first page 400 also includes functionality to allow a user to log in as an existing user, by entering appropriate information in the username field 402 and password field 403, in order to check on the status of the fund verification process, alter details about themselves, and provide administrative oversight to the P-Cards that have been created for them.

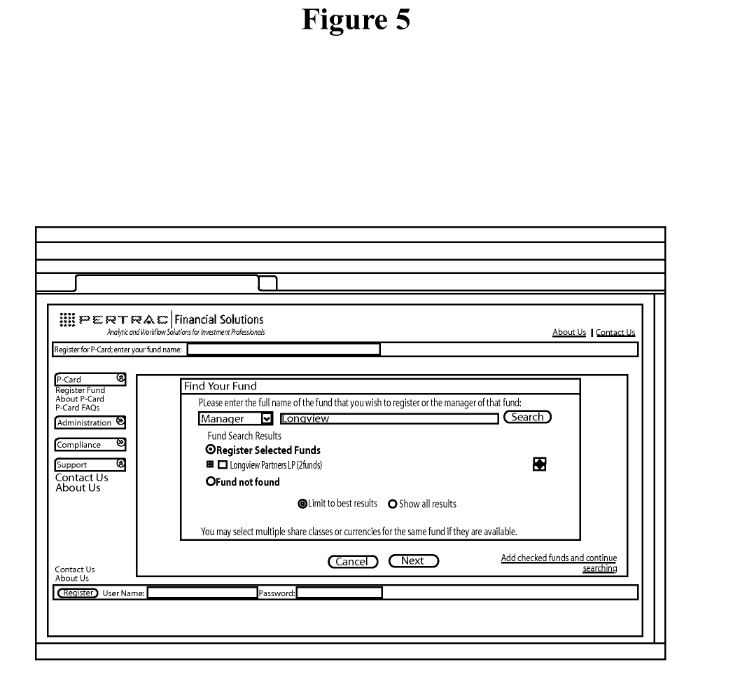

FIG. 5 illustrates the second web page 500 which provides an alternative access into the hedge fund database and provides a manager with extra flexibility. On the second page 500, the manager can create a search within the search box 501 either by focusing on the name of the fund management company or by putting in the name or partial name of a fund. The search facility embodied in the present invention allows a hedge fund manager to locate their funds either by searching for their registered fund name or the name of the fund management entity, both in whole or part.

In the present invention, the search engine that drives the results for any query provided in the search boxes shown, is provided with parameters 502 so that query results can either be set to limit matches specifically to the entered words, or can be used to show any results where one or more of the words entered form part of the fund name or fund manager name or not. In testing, the first search methodology provides an average accuracy rate of 95%, which indicates that it brings back an extremely accurate result.

In the present invention, the underlying fund database architecture that supports the web search provides search results that are presented to aggregate fund information associated with a fund manager. In other words, a search created by fund manager 503 will yield the aggregated view of all funds that have been found associated with a manager. While this type of function is available in standalone hedge fund databases, as the database underlying this search is an aggregated view of a large number of databases, it represents a consolidated, de-duplicated view of a hedge fund manager and each of their hedge funds. This database is a unique asset associated with the registration process, and is currently capturing more than 40,000 representations of funds.

In the present invention, the web elements that drive the registration process can operate without the user finding anything in the database or only finding a partially correct result. In other words, an embodiment of the present invention provides the mechanism, through a web service preferably, for a hedge fund manager to both identify an existing database entry as well as provide basic details for an entry that they wish to include in the database. The inclusion of a new data item in the central database is not a process that occurs in real-time, but is rather defined as a request, where post-verification, an entry made by a hedge fund manager is accepted into the database. This registration methodology is highly scalable and can be achieved with much less data entry than any other system.

The fund information required by the database to create a request consists of a very small number of elements.

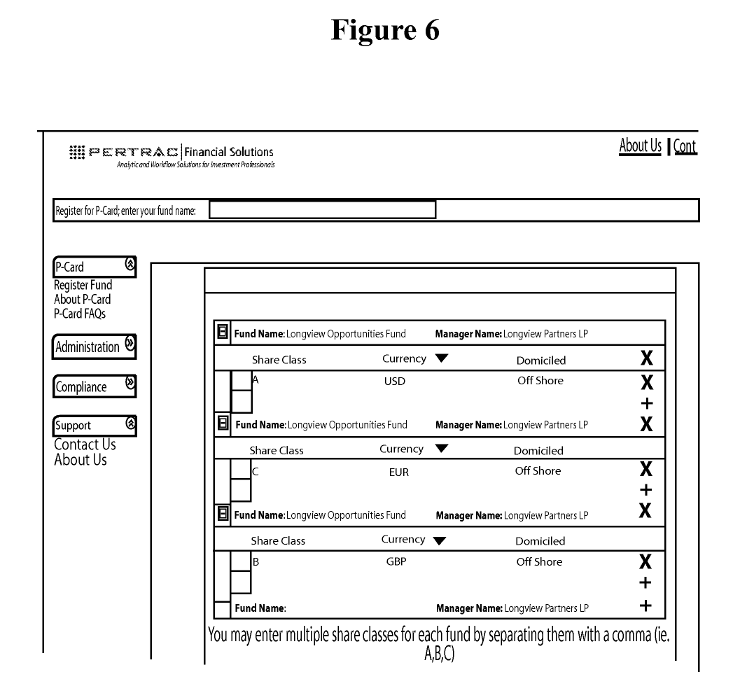

FIG. 6 illustrates the third page 600 for registration of an existing fund. This web page contains a table 601 where a manager adds additional fund attributes, such as the individual designated unit of share class or classes associated with a fund, the currency of the units issued in the fund, and the registration status of the fund, i.e. onshore/offshore The illustrative embodiment of the present invention allows a hedge fund manager to provide information on funds not located in the database as part of the registration process.

For a completely new fund that has not been found in a prior search, a Hedge Fund manager enters in information on both the fund name 602 and the fund management company 603. The manager also enters details around the currency denomination of the fund 604, the issuing classes of shares 605, and the fund registration details 606.

In an embodiment of the present invention, in order to add information about a fund or funds found in a search, the process is different, and for this situation, the registration process requires the user to add new information into the appropriate fields. The new information will either be associated with the share class, i.e. the designated form of the units that limited partners have purchased in the fund, the currency denomination of these units, or the status of the fund on which the units are issued from a registration viewpoint. A hedge fund manager cannot register an existing fund as a new structure unless one of these elements is different from one already in the database.

In the present invention, the functionality that drives the fund information request is flexible to recognize that a fund manager may have issued a number of different classes in the same currency denomination depending on when the fund was launched and reopened. In this way, a manager can register multiple funds with different share classes but other similar features in a single entry.

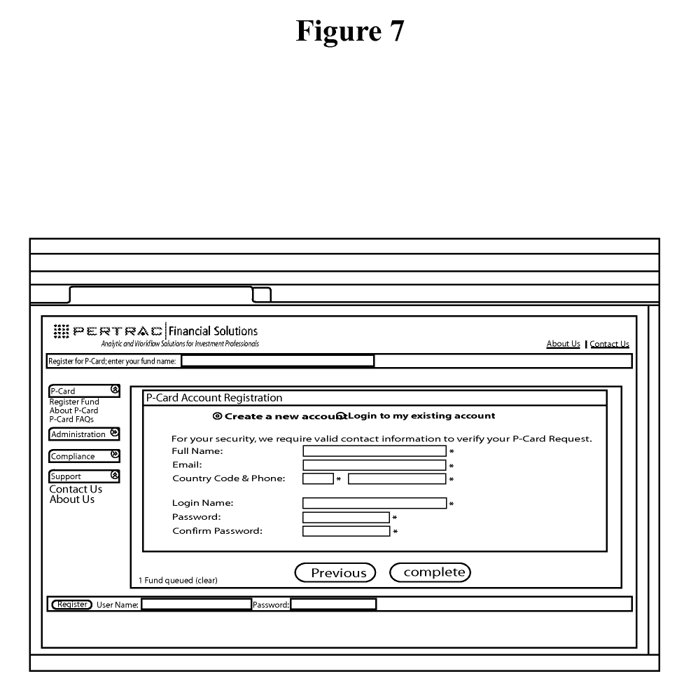

FIG. 7 illustrates the fourth page 700 that the hedge fund manager must complete as part of the first element of the P-Card data management process, and the fourth step in the find registration process. The illustrative embodiment of the present invention establishes that P-Cards can only begin the verification process if 2 valid points, the registered user themselves 701 and the compliance officer 702 are provided by the hedge fund manager as part of the registration process.

In the illustrative embodiment of the present invention, the hedge fund manager has a mandatory requirement to populate all the fields in the registration table 703 that are presented on the page in order to complete the P-Card fund registration process.

The hedge fund manager is required to provide two levels of contact in order to qualify for the verification process, a first line contact, who is expected to update and maintain P-Cards via the second element of the data management process, the P-Card Generator, and a compliance person. The compliance person must be different than the point of contact in both name as well as e-mail 704, and must go through a separate verification process with the fund administrator in order for any registered fund requests to be verified.

As part of this web page, the hedge fund manager will also create a user name 705 and password 706 that must consist of both numeric as well as textual values and must be a minimum of 6 characters in length. This user name and password will not only control access to the web service for future usage by the hedge fund manager, but will also be required by the hedge fund manager when using the P-Card Generator to acquire registered funds that have been verified.

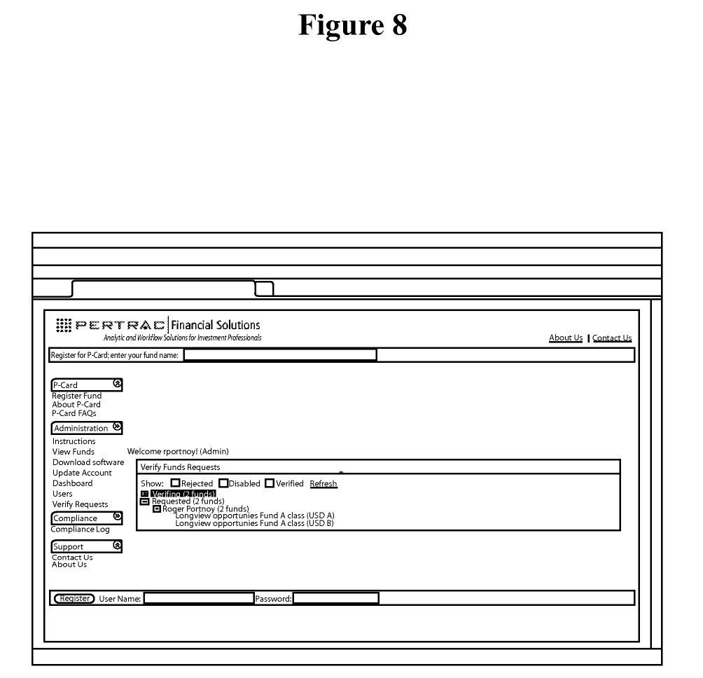

FIG. 8 illustrates the fifth page 800 of the web service, that forms part of the first element of the data management process, and the opening page of the verification process that is undertaken by the fund administration officer employed by the system. The fund administrator is provided with access to information regarding all funds for which registration has been requested 801 and can obtain a summarized view on which funds are enabled, disabled, and yet to complete verification 802. The illustrative embodiment of the present invention provides the means for the administrator to directly alter the status of all registered funds within the P-Card database.

In the illustrative embodiment of the first element of the present invention, when the fund administration officer logs into the web service, they will be presented with a summary screen of all fund requests that have been made organized by registration request date 803. As a general rule, the fund administration officer will review every fund request in about 48 hours.

In the illustrative embodiment of the present invention, every request made by a hedge fund manager can be organized by the fund administrator in a variety of ways. The fund administrator can view requests by registered contact, by registered fund manager, and by fund name 804.

The fund administrator can also, in the illustrative embodiment of the present invention, review funds by the status of their P-Card 805. For P-Cards that have already been verified, the administrator can review if a hedge fund manager has already downloaded the P-Card certificate or has disabled it from usage on the system. The administrator can also review funds that have not been verified yet or have been rejected on account of missing data or inconsistent data entry.

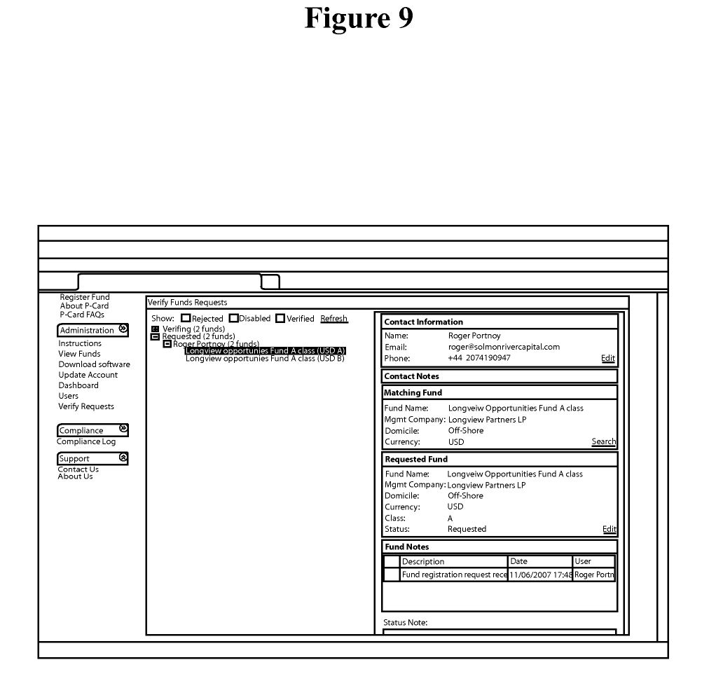

FIG. 9 illustrates the sixth page 900 of the web service that forms part of the first element of the data management process, and the second page of the verification process that is undertaken by the fund administration officer employed by the system. The web page of this stage of the administration process captures the summary details of a registered fund 901 and gives the fund administrator the opportunity to accept or reject the fund for P-Card creation based on these details 902. The illustrative embodiment of the present invention allows the fund administrator to accept or reject either a single fund registered by a hedge fund manager or multiple funds based on different share classes, currencies, or registration status.

This page 900 provides the fund administration officer with the detailed registration information that is associated with an individual fund, and represents the content that the fund administration officer needs to verify in order to accept the registration, and create a P-Card certificate for one or more funds that have requested registration 901.

The fund administration officer needs to perform a number of different functions in this aspect of the present invention in order to accept a fund. First they must seek to match the fund details that have been provided to a registered fund held within the ID database (FIG. 3, Step 1). This database represents an aggregated view of all funds that are registered with database vendors who distribute their data via the system manager.

The fund administration officer will see any funds that already exist which match the request. A matching fund may share certain details with the requested funds, but may be different, for example, in terms of the share class or currency.

Beyond matching fund details, in this stage of the illustrative embodiment of the present invention, the fund administration officer must also verify the point of contact. This is done through an electronic communication with the compliance officer that has been registered by the user. (FIG. 3, Step 2) The compliance officer must verify that the contact person is employed with the fund manager and has direct or indirect control over the production of content that is distributed to investors and other trusted parties.

All new funds must go through this two stage verification process automatically in this embodiment of the present invention, but once the verification process has been done for one fund, verification can take place without further contact being made with the compliance officer.

In accepting a fund request for inclusion in the P-Card database, a fund administrator, in creating the certificate will do one of two things. In cases where the fund for which registration is requested was matched correctly, the acceptance process will, in this embodiment of the present invention, lock the fund from further registration. (FIG. 3, Step 3) In other words, it will not allow any other individual or organization to register the fund a second time.

In cases, where the fund was not found, once the full verification process has been completed, the fund will be added to the ID database as a new fund, with P-Card assigned as the primary source for the purpose of tracking duplicates that might appear in the future. (FIG. 3, Step 4) The acceptance process used by the fund administration officer in this case will also “lock” the fund from further registration.

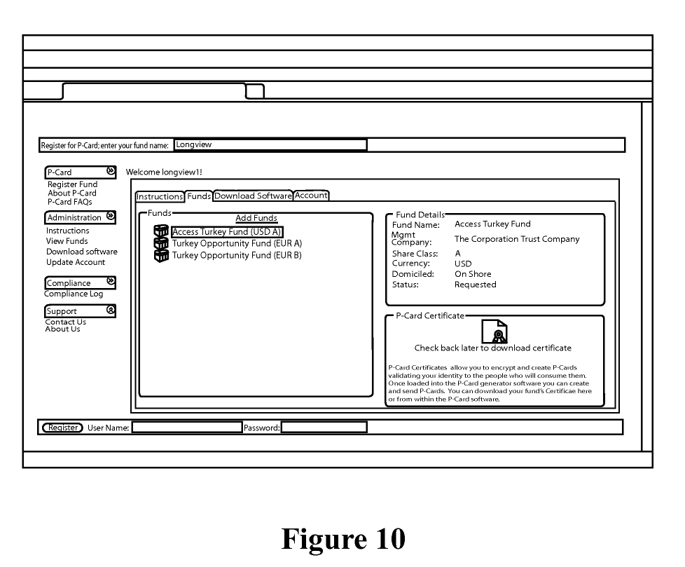

FIG. 10 illustrates the seventh and final page (1000) of the web service that forms part of the first element of the data management process in the illustrative embodiment of the present invention. The hedge fund manager can within the illustrative embodiment of the present invention check the status of any fund registered (1001), acquire a P-Card certificate for any fund (1002), and control the status of any fund (1003).

This page becomes available in the illustrative embodiment of the present invention after a hedge fund manager has completed the registration process in full. It can be accessed any time subsequently by the hedge fund manager, and is not dependent on whether the manager has had their funds verified or not.

Via this page in the illustrative embodiment of the present invention, the hedge fund manager can perform a number of functions. First, they can access the download page that will allow them to attain the second element of the present invention, the P-Card Generator. This is done via the Download Software tab (1004).

The hedge fund manager can also use the account tab (1005) available via this page to change their contact details. This could include making changes to the user name and password associated with the account.

This page also, via the funds tab (1006), in the illustrative embodiment of the present invention, provides the hedge fund manager with information about the status of their registered funds. There are two statuses that are associated with a requested fund. The first status is enabled (1007). In the enabled mode, the P-Card fund certificate can be downloaded by the hedge fund manager into the second element of the present invention, the P-Card Generator, and can also be distributed to investors using the P-Card Reader. A hedge fund that is enabled is one that has an active P-Card ID and can be decrypted.

The alternative status to the enabled mode is the disabled mode. A fund manager can set a fund to the disabled mode at any time once a fund has been verified and registered. In the disabled mode, a registered fund no longer carries a valid P-Card ID, and thus, even if it is sent out, the recipient will not be able to decrypt it and acquire data from it for use in a data management application.

When the disabled function is instigated by a hedge fund manager in the illustrative embodiment of the present invention, a notification will be sent to the fund administration officer who in turn will deactivate the P-Card ID within the P-Card database. The fund will remain registered and locked until either the hedge fund manager re-enables the P-card via their log-in or instructs the fund administrator to do so.

P-Card Generator

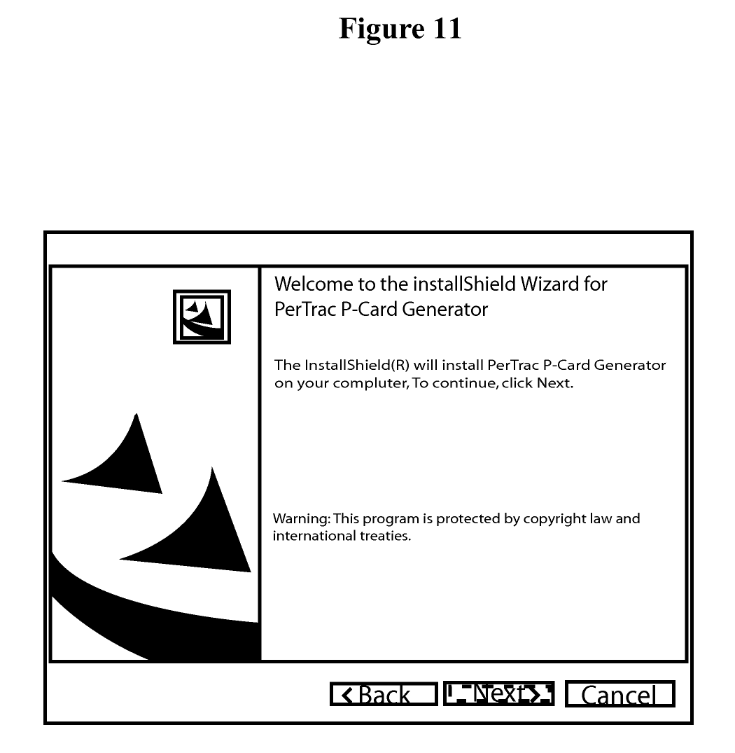

FIG. 11 illustrates the commencement of the installation process (A-0) that launches the second element of data management process of the present invention, the publishing application, known as the P-Card Generator. The hedge fund manager is required in the illustrative embodiment of the present invention, to go through an installation process to launch the software. The installation process must be completed for a hedge fund manager to launch the P-Card Generator.

The installation process can only be started by the hedge fund manager agreeing to the terms and conditions governing the usage of the software. Once this is done, the software application can be loaded into either a local directory, or a shared network drive.

The installation process for the illustrative embodiment of the present invention installs all of the components to import, format, populate, and generate a P-Card in a single executable process.

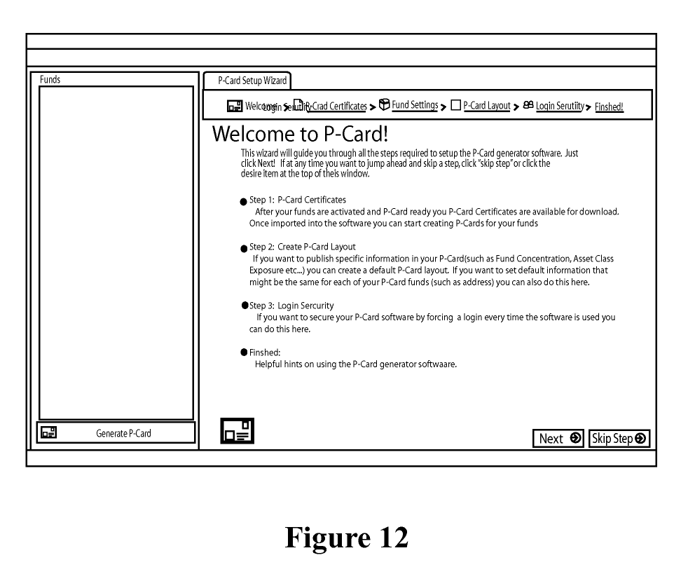

FIG. 12 illustrates the first component that becomes visible to the hedge fund manager using the publishing application, known as the P-Card Generator, the second element of the data management process of the present invention.

The set up wizard (B-0) offers the hedge fund manager a step-by-step process to acquire, configure, format, populate, and generate a P-Card. This process can either be introduced for all funds that are imported into the P-Card Generator, or can be followed for a single fund. The set-up process can also work as well for groups of funds, thus making it a completely flexible process that the managers can apply as they see fit.

Within the illustrative embodiment of the present invention, the set up wizard consists of 5 steps, one for acquiring registered and verified P-Card certificates (B-1), one for configuring the quantitative elements of a P-Card (B-2), a third for selecting the type of structure, both in terms of data elements and content that needs to go into a P-Card (B-3), a fourth for creating and configuring a distribution list for all of the recipients of a generated P-Card (B-4), and a final step to provide security measures around the update and publishing process itself (B-5).

Each of these different steps is controlled by a separate component function within the P-Card Generator and can be utilized both via the wizard and also via selective menu buttons visible in the P-Card Generator itself.

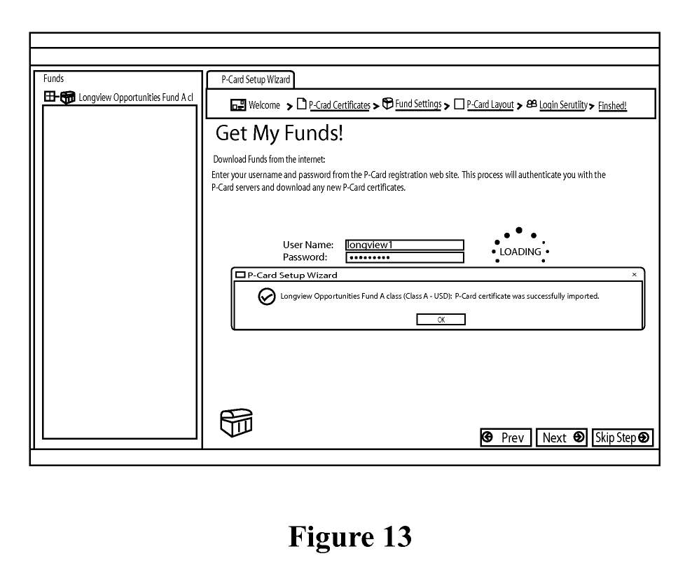

FIG. 13 illustrates the second component, the P-Card import module (C-0), of the data management process within the second element of the present invention, the P-Card Generator. This function controls the process by which a hedge fund manager acquires and integrates verified P-Card certificates within the P-Card Generator. This function can operate in the present invention as both an element of a secure password controlled data exchange over the internet or as a manual import process.

The import module can be launched from within the P-Card set up wizard or it can be used as a separate standalone element of the P-Card Generator (C-1).

The import module can be used in a number of different ways by the hedge fund managers. The two methods embodied in the version of the software in the illustrative embodiment are an automated routine utilizing a web service, and a manual routine.

In the automated routine, the hedge fund manager commences the import process by inputting the user name and password that they provided during the web registration process (C-2). Once this user name and password have been verified during a real-time data exchange, the user will automatically be sent those funds that have been verified against that user's contact details. The illustrative embodiment of the present invention, for this element, can import any verified funds against any correct user name and password within the same P-Card Generator.

The automated method of the present invention systematically checks the P-Card directory for funds already imported, and thus will not import duplicates of a P-Card once they reside inside of the P-Card Generator (C-3).

The automated routine of the illustrative embodiment of the present invention relating to the second element can be carried out for any number of funds, and will import each of the funds as a separately recognized entry.

If the hedge fund manager does not have internet connectivity on their local desktop, the P-Card import module can also be used in a manual method. In this routine within the illustrative embodiment of the present invention, the hedge fund manager specifies the location of the P-Cards and than manually imports them. This methodology does not require the hedge fund manager to provide their user name and password, unless it is part of the security function.

The import routine, whether manual, or automatic, will always pre-populate the small number of fields that are provided as part of the manual data entry process, and will use these fields as part of the naming convention for the P-Card itself which is created.

In the illustrative embodiment of the present invention, when a P-Card is imported into the P-Card Generator it is automatically time stamped and dated and these facets of the P-Card are saved so that one can compare different versions of a P-Card to one another (C-4).

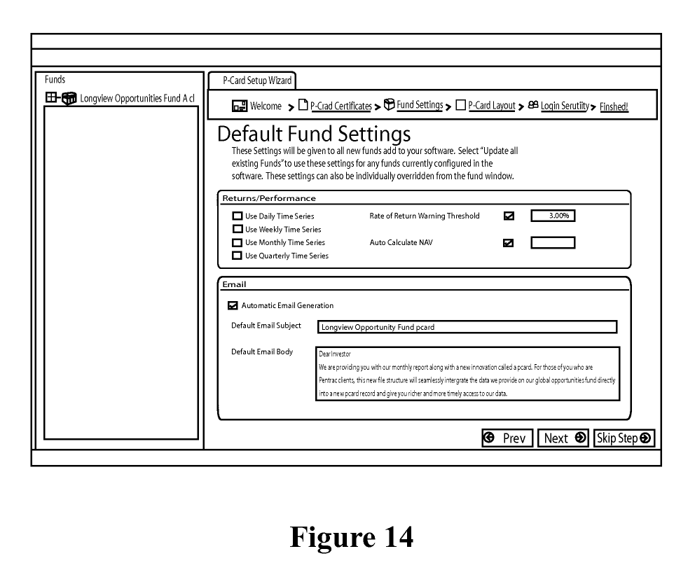

FIG. 14 illustrates the configuration module (D-0) which forms the second component part of the publishing application, known as the P-Card Generator, which is the second element of the data management process of the present invention. This function controls the process by which a hedge fund manager assigns specific field structures, as well as alerts and calculation methods to the quantitative data included in the illustrative embodiment of the present invention. The manager can assign these functions as a default layer to all of their P-Cards in the present invention or can apply a specific configuration to each P-Card fund certificate individually (D-1).

The configuration module can be applied to P-Card as a default setting for every P-Card imported into the P-Card Generator or can be configured individually for each P-Card.

The configuration module is used by a hedge fund manager to determine the time series of data that they want to add to the P-Card. In the illustrative embodiment of the present invention, a hedge fund manager can select to add a single time series or can add multiple time series. The available options in the present invention are daily, weekly, monthly and quarterly time series (D-2).

The configuration module also includes functions that allow a hedge fund manager to automate certain basic calculation and data management functions that are associated with a time series. In the illustrative embodiment of the present invention, a rate of return filter can be applied to this time series element (D-3).

A hedge fund manager can also, by providing an initial value, have his net asset values calculated automatically (D-4). This function uses the rate of returns for each sequential period against the starting net asset value for the fund.

The configuration module also includes a function to generate an automated e-mail message for each P-Card generated from within the P-Card Generator (D-5). The e-mail function will automatically launch the default e-mail application available on the desktop of the hedge fund user, and will automatically populate the body text and the subject box based on the inputs provided in the configuration module in this embodiment of the present invention (D-6).

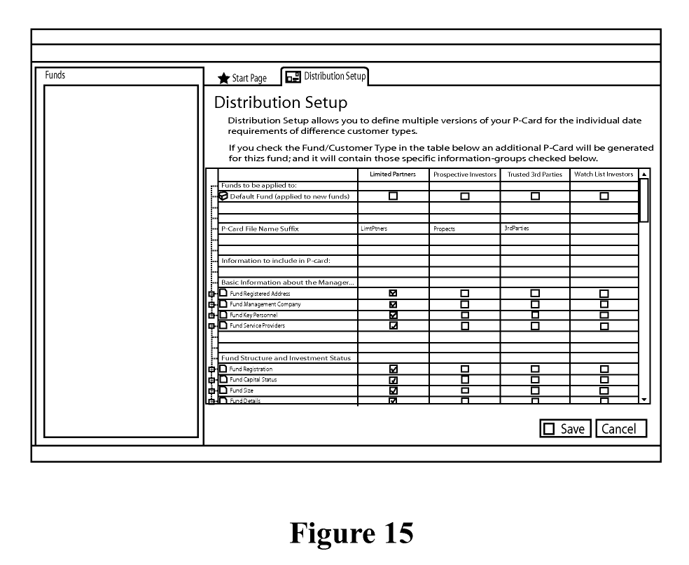

FIG. 15 illustrates a P-Card Distribution module (E-0) which forms the third component part of the publishing application, known as the P-Card Generator, which is the second element of the data management process of the present invention. This function allows a hedge fund manager to assign specific data elements represented within a P-Card to a particular recipient group (E-1). The data elements are assigned at a field group level and can be assigned to a single fund's P-Card or to multiple funds' P-Cards.

The recipient groups are organized to represent different types of investors that will have a relationship with a hedge fund manager. There are at present within the illustrative embodiment of the present invention four (4) investor groups that can be assigned to receive different fields available within a P-Card Template (E-2). The first group is the Limited Partners. Limited Partners represent existing shareholders to a particular fund. The second group is Prospective Investors. Prospective Investors represent investors who have not yet made a direct cash investment in the fund but have indicated an interest in getting more information about the fund on a regular basis as a means of determining whether to make an investment or not. The third group is Trusted 3^{rd} Parties. Trusted 3^{rd} Parties that are eligible to receive data from a hedge fund manager about a fund include service providers like Prime Brokers and Fund Administrators, as well as Database vendors that distribute fund data to qualified investors. The final group that is eligible to receive data are Watch List Investors. Watch List Investors are those that have gone through significant due diligence with a fund manager, and are now seeking assurance through performance data that a hedge fund manager is able to perform in the manner that they have indicated on a consistent basis.

A hedge fund manager has control over every field that has been included in a P-Card for every individual investor group and can either choose to share all data equally to every recipient or disclose only some data to selective groups and not to others (E-3).

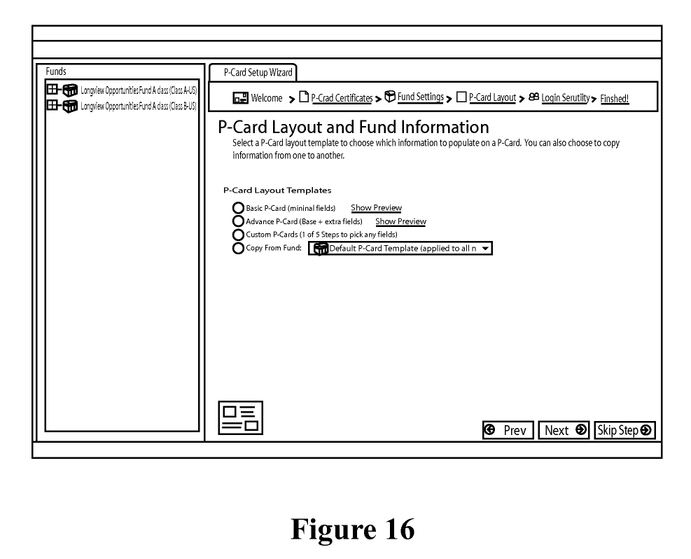

FIG. 16 illustrates the P-Card set-up module (F-0) which forms the fourth component part of the publishing application, known as the P-Card Generator, which is the second element of the data management process of the present invention. This function controls the process by which a hedge fund manager selects the structure of a P-Card for a particular fund, for a set of funds, or for all of their funds. The attributes of the format function in the illustrative embodiment of the present invention deliver both a fixed format approach made up of pre-selected fields and a completely customizable approach. (F-1) Through either method, a hedge fund manager can create, store, and eventually distribute both qualitative and quantitative content.

The P-Card set up module, as embodied in the illustrative embodiment allows a hedge fund manager to either select pre-defined data structures, to use a P-Card structure already assigned to an existing fund inside the P-Card Generator, or to create a completely customized data structure.

The present invention features a number of pre-defined data structures. The first of these is a basic P-Card layout. (F-2) This features a minimum number of essential field and data structures for both qualitative and quantitative data. There is also an advanced P-Card layout that is also pre-defined. (F-3) This layout features more detailed attribution data to apply to a fund.

In the illustrative embodiment of the present invention, the hedge fund manager, when selecting a layout can either populate the selected data elements to one individual P-Card or can have the information populated across a selection or even all P-Cards that are housed within the P-Card Generator. (F-4)

The structure of a P-Card can be applied as a default template for all P-Cards. When this is done according to the present invention, not only are the data fields and structures copied from one fund to another, but also the data that has been applied to one P-Card within a field is also applied to other funds.

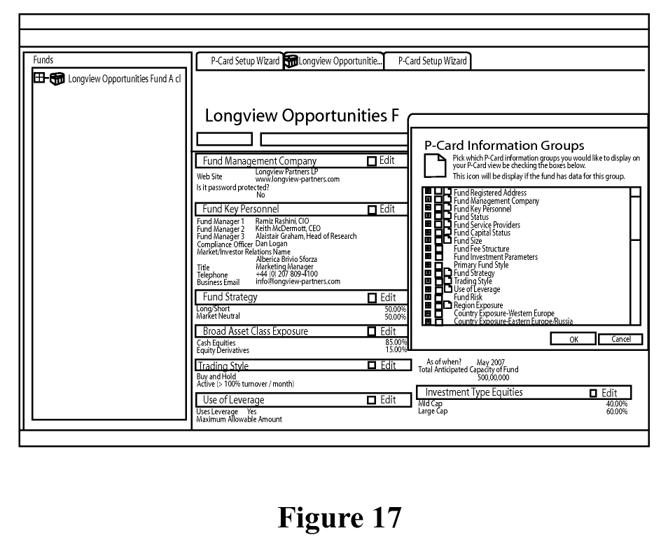

FIG. 17 illustrates the P-Card customization module (G-0) which forms the fifth component part of the publishing application, known as the P-Card Generator, which is the second element of the data management process of the present invention. This function controls the process by which a hedge fund manager expands and contracts the attributes of one or more P-Cards. Through the current structure of this function, the hedge fund manager is able to define which groups of attributes are to contribute to a P-Card and can additionally populate the content of the underlying fields through the illustrative embodiment of the P-Card Generator invention. (G-1) The business process of the illustrative embodiment of the present invention associates a field to a specific structure, thus ensuring a consistent format for every field that is selected by the manager to include in their P-Cards. (G-2)

In the illustrative embodiment of the present invention, the customization module is designed to give a hedge fund manager complete control over the P-Card data structure. Control over data management is provided at both the group level as well as the field level. Assigning data management at the group level allows a hedge fund manager to acquire all of the underlying fields within a group hierarchy. (G-3)

The customization module allows the hedge fund manager to populate their P-Card with any set of data, and to control how that data is displayed on the P-Card. Data Management can be handled at an individual fund level or can be allocated as a default setting for all or some portion of the funds that are stored inside the P-Card Generator.

The customization module, in the illustrative embodiment of the present invention, has select, edit and confirms functionality associated with each field. The select function assigns a field or group of fields to a P-Card; the edit function provides the means for data to be added to a field; while the confirm function, saves the data to the field. (G-4) The hedge fund manager can only confirm data structures that are aligned to the data definition for that field. In other words, a text field can be edited via text rules, while a numeric one would follow numeric guidelines.

The customization module does not control the quantitative time series data displays which are managed via the configuration module.

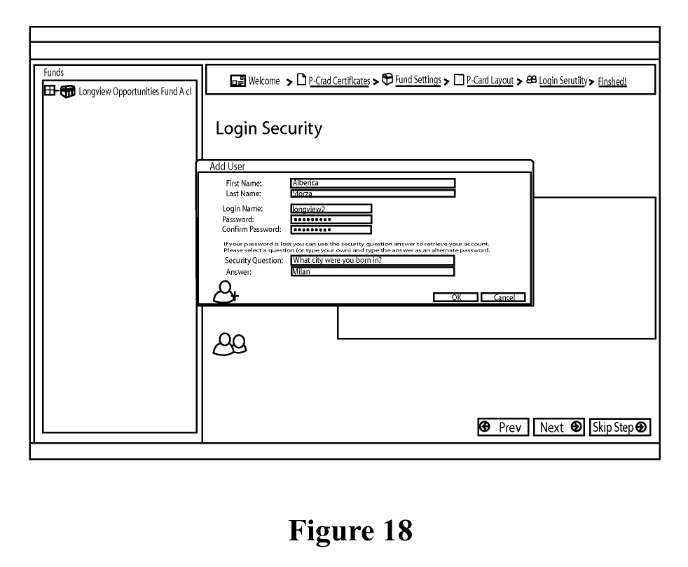

FIG. 18 illustrates the P-Card security module (H-0) which forms the fifth component part of the publishing application, known as the P-Card Generator, which is the second element of the data management process of the present invention. This function allows a hedge fund manager to add password security for every specific user of the present invention, known as the P-Card Generator. The present invention can be operated without any log-in security being required, but can also be configured so that every user has and must use their own password. (H-1) This function provides the illustrative embodiment of the present invention with a permission capability that can be directly linked to registered funds.

The security module provides the means, in the present invention, for the hedge fund manager to permission different users within their own organization to use the publishing application, known as the P-Card Generator.

The core function of the security module is the ability to create and save individual user name and passwords in a password database as part of the P-Card Generator. The hedge fund manager is not obliged to use this module to run the software, but when they do so, any user will be required to enter a correct user name and password to access the software and to edit a saved P-Card.

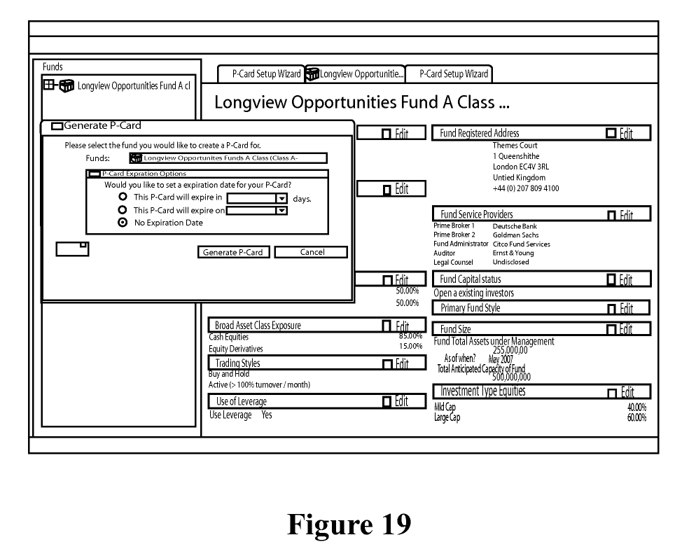

FIG. 19 illustrates the P-Card Generation module which forms the sixth and final component part of the publishing application, known as the P-Card Generator, which is the second element of the data management process of the present invention. (I-0) This function allows a hedge fund manager to convert the P-Card stored within the P-Card Generator into a new encrypted file structure. The illustrative embodiment of the present invention known as the P-Card Generator allows the hedge fund manager to include in the encryption process other file structures, such as spreadsheets, word documents, and postscript documents, thus allowing more than one format to be distributed via the P-Card mechanism. (I-1) The illustrative embodiment of the present invention does not place any restrictions on the number of types of files that are attached to a P-Card.

The Generation function is delivered within the illustrative embodiment of the present invention as a stand alone component which a hedge fund manager executes for each individual P-Card that they create within the Generator.

The Generation function provides the ability of a hedge fund manager to apply a temporary user license to any created P-Card. This license effectively disables access to content stored in the P-Card either after a set number of days or on a specific date onwards. (I-2)

The Generation function is responsible for building the P-Card in the illustrative embodiment of the present invention. The P-Card can be named and saved in a pre-defined default structure or in a user defined form, provided that the user assigns the correct extension to the P-Card when it is being saved. A P-Card can be stored in any location. (I-3)

In the illustrative embodiment of the present invention, when a P-Card is generated, three functions are triggered via this action.

First, a backup version of the P-Card is created and stored in a pre-assigned directory. This backup version is time and date stamped. Second, this version is saved as a read-only file and becomes a matter of record.

Finally, if e-mail generation has been set in the Configuration module, upon the P-Card being saved, the default e-mail service will be launched, and the P-Card attached.

P-Card Import Tool and Reader

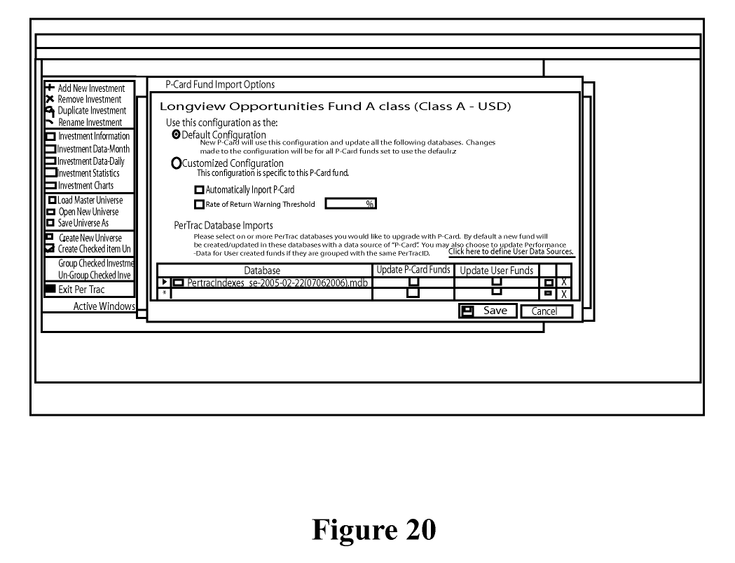

FIG. 20 illustrates the first component, the Import Configuration Module of the data management application known as the P-Card Reader, which is the third element of the present invention. (J-0) This component can, in the illustrative embodiment, be launched either as a function of the Pertrac Analytics platform, or as a standalone import tool. This function provides a hedge fund investor of any type with a tool that identifies new P-Cards that have been received via a distribution mechanism, such as e-mail, and to configure various elements of the P-Card. These elements relate to both data management aspects as well as alerts associated with transmitted data.

The import configuration module is the first component that a hedge fund investor must use if they wish to import a P-card successfully into a data management application. In this module, the user defines a series of import rules that will operate either for a single P-Card or for all P-Cards that are to be imported into the data management application. (J-1)

The Import Rules that can be Specified in the Present Invention Include Rules governing the automation of the import process itself, creating alerts around specific changes that may be presented within a given P-Card from version to version, and specifying which elements of the data management application, the P-Card will interact with.

In the illustrative embodiment of the present invention, a P-Card can be assigned to a specific database being maintained by a hedge fund investor to store content about hedge funds. (J-2) The P-Card data can be assigned to more than one database if multiple databases are being maintained for this purpose.

The P-Card can also be configured so that certain data flows into different templates or records that might be a core part of the database structure itself. (J-3) The P-Card will automatically provide the user with a record based around the provided fields within the P-Card itself and will source this to the P-Card within the database.

The P-Card can also be configured, in the illustrative embodiment of the present invention to contribute new data to user created records. (J-4) In such cases, the hedge fund investor must first select which records they wish to update. Once this process has been done, the hedge fund investors can use the data provided within the P-Card to update certain fields in their own records.

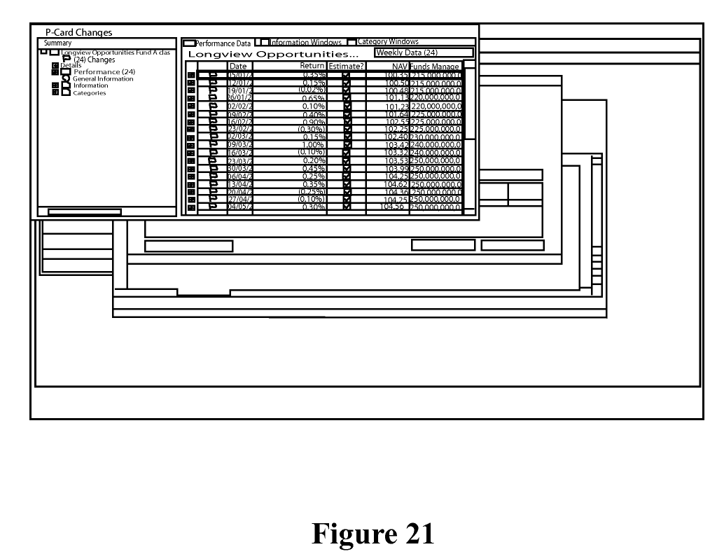

FIG. 21 illustrates the second component, the Data Review Module of the data management application known as the P-Card Reader, which is the third element of the present invention. (K-0) This function allows a hedge fund investor to review all fields populated within a P-Card and any changes made in a field from one update to another prior to importing the data into a data management application such as the Pertrac Analytics platform.

The Data Review Module of the illustrative embodiment of the present invention operates within a second window once a hedge fund investor clicks on the review changes button in the Import Module. (K-1)

The review changes button is populated on two occasions within the illustrative embodiment of the present invention, 1) when a P-Card is loaded for the first time into the P-Card Reader for configuration; and 2) when actual changes occur within one version of the P-Card versus the most recent version of the P-Card for the same fund. A change is not only one value being different from another, but also a field being populated that had previously been null or blank. The P-Card Reader recognizes both of these situations as changes.

The data review methodology in the present invention compares the most recent P-Card based on its creation date to the next most recent. The data display compares entries in populated fields between the two P-Cards and displays those elements that are different.

In creating the display, data is grouped into different categories. These categories represent in the illustrative embodiment of the present invention, summary levels for different types of data, ranging from qualitative data about a fund or fund management entity, investment attribution data based around the strategy of the fund, and quantitative data relating to the rate of return of the fund, as well as net asset value. (K-2)

The data is displayed in the illustrative embodiment of the present invention in a comparative manner. Specifically the hedge fund investor is able to easily visualize old values and information against recent ones in the same table rows. If there are multiple changes to a field these are displayed in the same way. Thus one vs. multiple changes in a field in a new version vs. an old one is displayed in the same manner.

The comparative data display process is only used when there are two values. When there is a new value, the display will show the new value against a blank cell, or will show there are data elements for different periods where there were none previously displayed. Thus, in the illustrative embodiment of the present invention, new data is dealt with different from data changes, making the two easily recognizable to the hedge fund investor.

In the diagram presented (K-0), an embodiment of the present invention, the most recent version of the P-Card for the fund being reviewed did not include weekly data, but the update has provided it. Thus, the performance category is highlighted, and all of the new data is displayed as a change along with other data that is also populated in other columns. (K-3) The side bar highlights which groups have changed, and the number of changes, in terms of rows, not fields.

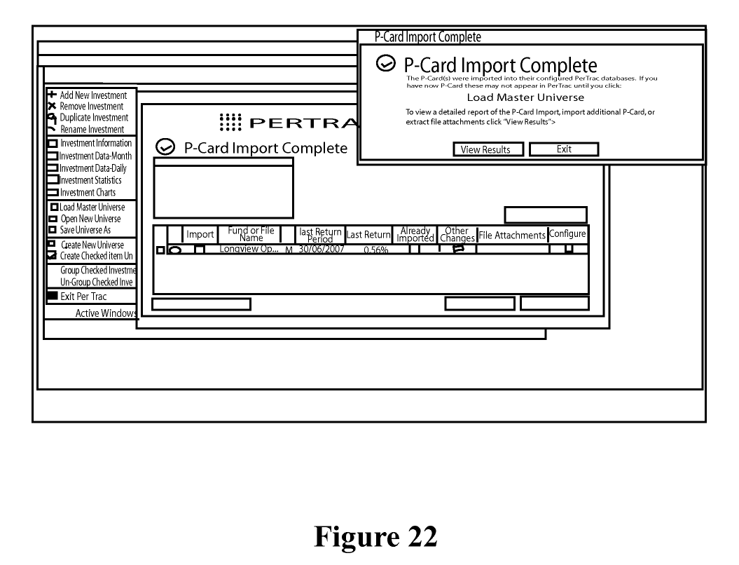

FIG. 22 illustrates the third component, the Data Import Module of the data management application known as the P-Card Reader, which is the third element of the present invention. (L-0) In this aspect of the process, the hedge fund investor can detach and save wherever they wish, any attachment files that were transported via the P-Card, and can create a completely configured and pre-populated record of all data transported within the P-Card. The import function can also create other types of formats and link to other types of database and data management applications making it a completely flexible distribution environment.

The Data Import Module is, in the illustrative embodiment of the present invention, responsible for the decryption of the P-Card data, the verification of the P-Card status, and the loading of the P-Card data into the database application. (L-1)

The import function is used by the hedge fund investor as a means of decrypting the XML data elements of the P-Card and transforming these elements into whatever form is required by the consuming data management application. The transformation of the XML data layer could be into a delimited format, a format suitable for an application like a spreadsheet or could be for a specific data management and analytic tool.

In the case of the integration into a specific application, the illustrative embodiment of the present invention is capable of not only the verification of the P-Card status but also verification of a set of security instructions for the use of the application as part of the same process.

The import function in the present invention can be assigned as a single P-Card import or can also be run as a batch import. Both of these processes can either be fully automated, via the configuration module in the illustrative embodiment of the present invention within the P-Card Reader or can be part of a manual review process. (L-2)

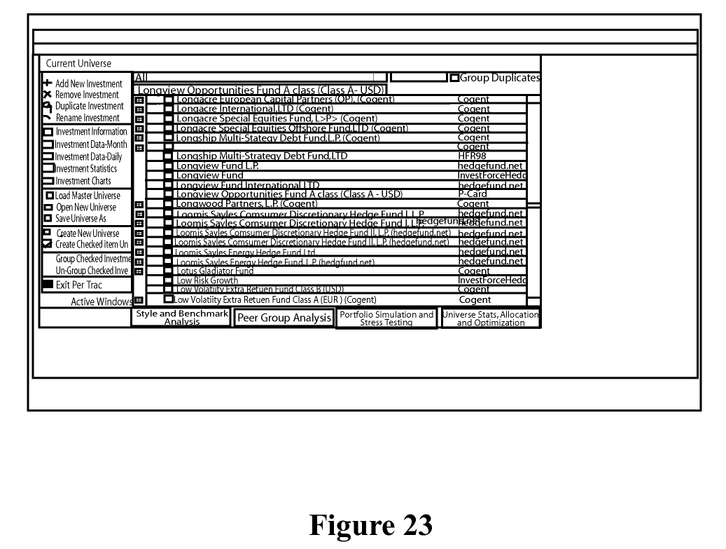

FIG. 23 illustrates the fourth component, the P-Card Sourcing Module of the data management application known as the P-Card Reader, which is the third element of the present invention. (M-0) This represents the next to the last of the data management process. In this step, the imported P-Card is assigned as an available data source, and non-duplicate records are displayed as sourced directly from a received P-Card.

The sourcing module in the illustrative embodiment of the present invention identifies the P-Card file as a data source in its own right, and makes it recognizable amongst other sources in a multi-database environment.

In the example screen shot, the multi-database environment, where the P-Card has been imported is the Pertrac Analytics Platform. (M-1)

In the present invention, the import process creates a new record based on the P-Card file and also links this to a new data source. The P-Card, as a data source can be referenced like any other database in an analytics environment, for example, as is the case in the diagram. (M-2)

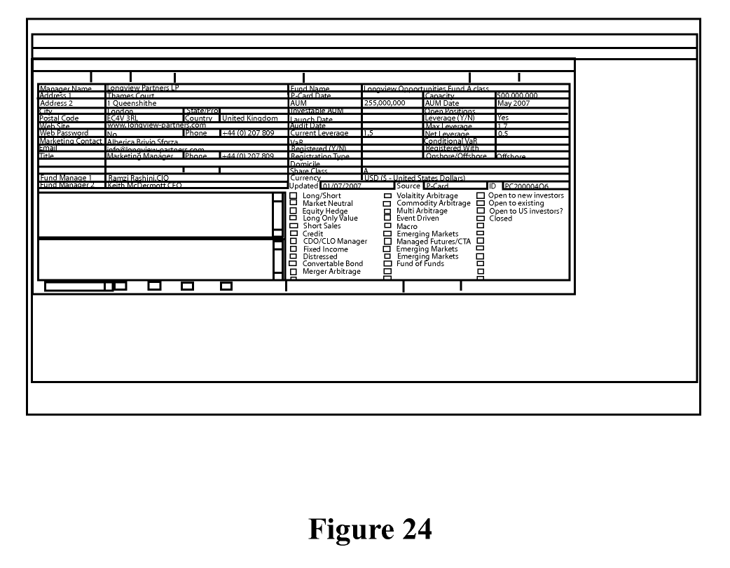

FIG. 24 illustrates the final component, the Data Display & Integration Module of the data management application known as the P-Card Reader, which is the third element of the present invention. (N-0) This represents the last element of the data management process. At this level, a client of an analytics platform, such as the one shown in the diagram, the Pertrac Analytics platform, can visualize see every populated element of the P-Card customized for them by the hedge fund manager, and can use all aspects of the analytics platform with the various quantitative elements that were contained within the P-Card. (N-1)

This module is responsible in the illustrative embodiment of the present invention for the conversion of the P-Card data set into other types of data configurations.

The one represented in the diagram is the configuration that is used for data presentation within the Pertrac Analytic Platform. In this configuration the data is managed across multiple layout screens, with each screen presenting different elements of the data that is distributed via the P-Card. (N-2)

In the illustrative embodiment of the present invention, this element of the P-Card Reader recognizes and maps both qualitative as well as quantitative data and maps each into the appropriate fields and tables, making all elements available for different types of functions available within the analytics platform. Where appropriate, the transformation process reads data against pre-defined tables, and applies true/false measures in order to check off the relevant fields.

The transformation process of the present invention time and date stamps all of the elements that are individually transformed, and thus provides the framework to treat each data item as part of a time series.

While the present invention has been particularly shown and described with reference to preferred embodiments thereof, it will be understood by those skilled in the art that various changes in form and details may be made therein without departing from the spirit and scope of the present invention.

We claim:

1. A method of managing and distributing data concerning one or more hedge funds, the data stored in a database having at least one data record associated with each of the one or more hedge funds, each data record having a plurality of data fields defined by a predetermined schema and each data field storing data concerning the particular hedge fund, the method comprising the steps of:
obtaining information concerning a particular hedge fund;
extracting data from the obtained information;
selecting a master data record associated with the particular hedge fund;
modifying the master data record associated with the particular hedge fund based on the extracted data;
retrieving a first configuration associated with a first recipient of hedge fund information, the first configuration identifying a set of the data fields defined by the predetermined schema for which the first recipient is eligible;
generating at least a first data record having a plurality of data fields defined by a first configuration schema associated with the first recipient;
populating the data fields of the first data record with data from the master data record based on the retrieved first configuration; and
distributing the first data record in a secure manner to the first recipient.

2. The method of claim 1 further comprising the steps of:
retrieving a second configuration associated with a second recipient of hedge fund information, the second configuration identifying a set of the data fields defined by the predetermined schema for which the second recipient is eligible;
generating at least a second data record having a plurality of data fields defined by a second configuration schema associated with the second recipient;
populating the data fields of the second data record with data from the master data record based on the retrieved second configuration; and
distributing the second data record in a secure manner to the second recipient,
wherein the first recipient and the second recipient are different and the first configuration and the second configuration are different.

3. The method of claim 1, wherein the first data record is distributed in a secure manner by encrypting at least the first data record and transmitting the first data record to the recipient by electronic mail.

4. The method of claim 3, wherein the encryption includes public-key encryption.

5. The method of claim 1, wherein the first configuration schema is the predetermined schema.

6. The method of claim 1, wherein the first configuration schema is defined by the first recipient.

7. The method of claim 6, wherein the first configuration schema is different than the predetermined schema.

8. The method of claim 7, wherein the first configuration schema defines at least one data field that is populated during the generation process by the steps of:
analyzing at least a portion of the data concerning the particular hedge fund; and
applying a formula to the portion of the data.

9. The method of claim 8, wherein the analyzing step includes an analysis of at least a portion of data of a plurality of hedge funds.

10. The method of claim 1, wherein the first recipient includes a plurality of destinations.

11. The method of claim 1, further comprising the steps of:
determining whether the particular hedge fund corresponds to one or more data records in the database; and
selectively creating at least one new data record associated with the particular hedge fund if no corresponding data record is in the database.

12. The method of claim 1, further comprising the steps of:
comparing the obtained information to information concerning a known hedge fund from a plurality of information sources;
determining whether the obtained information concerns the known hedge fund; and
selectively associating the particular hedge fund with the known hedge fund.

13. The method of claim 1 further comprising the step of verifying the extracted information for compliance with a predetermined structured format.

14. The method of claim 1, wherein the generating step is performed in response to the step of modifying the master data record.

15. A method of managing and distributing data concerning one or more hedge funds, the data stored in a database having at least one data record associated with each of the one or more hedge funds, each data record having a plurality of data fields defined by a predetermined schema and each data field storing data concerning the particular hedge fund, the method comprising the steps of:
obtaining information concerning a particular hedge fund;
extracting data from the obtained information;
selecting a master data record associated with the particular hedge fund;
modifying the master data record associated with the particular hedge fund based on the extracted data;
retrieving a plurality of configuration files, each configuration file associated with a respective recipient and identifying a set of the data fields for which the respective recipient is eligible;
generating at least one new data record for each respective recipient, the at least one new data record having a plurality of data fields defined by the configuration schema associated with the respective recipient;
populating the data fields of each of the at least one new data records for each respective recipient with data from the master data record based on the configuration associated with the respective recipient; and
distributing each new data record to the respective recipient in a secure manner.
